(19) United States
(12) Patent Application Publication
(10) Pub. No.: US 2002/0016853 A1
(43) Pub. Date: Feb. 7, 2002

(54) Method and apparatus for transferring data between computing systems

(76) Inventor: Bryan Ressler, Mountain View, CA (US)

Correspondence Address: BEYER WEAVER & THOMAS LLP, P.O. BOX 778, BERKELEY, CA, 94704-0778, US

(21) Appl. No.: 09/770,090

(22) Filed: Jan. 24, 2001

Related U.S. Application Data
(60) Provisional application No. 60/178,509, filed on Jan. 27, 2000.

(51) Int. Cl. G06F 15/16; G06F 17/30

(52) U.S. Cl. 709/236; 707/10; 709/217; 707/101

(57) ABSTRACT

A method for transferring data from a first computer system to a second computer system is provided. Generally, data from a plurality of first source database records is packed into a small set of large records. The small set of large records is transferred from the first computer system to the second computer system. The small set of large records is then unpacked into a plurality of database records.

A method for transferring data from a first computer system to a second computer system is also provided. Generally, a plurality of source databases are encapsulated into a single encapsulated database. The encapsulated database is transferred from the first computer system to the second computer system. The single encapsulated database is then unpacked into a plurality of destination databases.

### RELATED APPLICATION DATA

The present application claims priority from U.S. Provisional Patent Application No. 60/178,509 for CRUSH PALM DATABASE INSTALLATION TECHNOLOGY filed on Jan. 27, 2000, the entirety of which is incorporated herein by reference for all purposes.

### BACKGROUND OF THE INVENTION

The present invention relates to transferring information from one computer system to another. More specifically, the present invention provides methods and apparatus by which data may be transferred from a computer system to a personal digital assistant (PDA) computer system.

In the transfer of records of a database from one computer system to another computer system, more particularly in the transfer of records of a database from a computer system to a PDA system, such as a system using a Palm™ Operating System, the records may be sent individually. The Palm™ Operating System may use a program called HotSync™ to synchronize databases on a computer system with a database on a PDA system using the Palm™ Operating System. Generally, the HotSync™ program may require a series of executed commands and acknowledgements for each record that is transferred. When a large number of records are transferred, the series of executed commands and acknowledgements may consume a large amount of time, which causes the transfer process to be slow.

FIG. 1 is a schematic illustration of a HotSyncTM process. During the HotSync™ process, a first install may be performed (step 104). During this step, some of the programs or data, which do not require record-level manipulation, may be transferred from a computer system to a personal digital assistant. Next, a conduit step may be performed (step 108). During this step, a conduit, such as a plug-in or DLL, may manipulate records in a database to be transferred to the personal digital assistant. Such manipulation may allow a synchronization between a changed database on the personal digital assistant and a changed database on the computer system, which may require a record level comparison. Next, newly available databases as a result of the conduit step may be transferred from the computer system to the personal digital assistant (step 112). Finally a HotSync™ message step (step 116) may be performed. During this step, a “HotSync™ notification” message is sent to various personal digital assistant applications to notify these applications that a HotSync™ has been performed.

There are two kinds of Palm OS databases. There are “pdb” databases, which are record databases and “prc” databases, which are resource databases. In a pdb (record) database the records are identified in numerical order. In a prc (resource) database the records are identified a four character type and a 16-bit numerical ID. For the Palm OS all programs may be downloaded as databases. A program may be in the form of a prc database, with data used by the program in a pdb database.

### SUMMARY OF THE INVENTION

To achieve the foregoing and other objects and in accordance with the purpose of the present invention for transferring data from a first computer system to a second computer system, generally, data from a plurality of first source database records is packed into a first single record. The first single record is transferred from the first computer system to the second computer system. The first single record is then unpacked into a plurality of database records.

Another embodiment of the invention provides a method for transferring data from a first computer system to a second computer system. Generally, a plurality of source databases are encapsulated into a single encapsulated database. The encapsulated database is transferred from the first computer system to the second computer system. The single encapsulated database is then unpacked into a plurality of destination databases.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic view of a HotSync™ process used in the prior art.

FIG. 2 is a schematic illustration of a system, which may be used by a preferred embodiment of the invention.

FIG. 3 is a schematic illustration of a process used in a preferred embodiment of the invention.

FIG. 4 is a schematic illustration of an example of how a PDB file is repackaged into a into a PRC file.

FIG. 5 is a graph which shows HotSync™ install times and Crush install times versus number of records transferred.

FIG. 6 is a schematic illustration of another embodiment of the invention.

FIG. 7 is a high level flow chart of the process used in encapsulation.

FIGS. 8A and 8B illustrate an example of a computer system, which is suitable for implementing embodiments of the present invention.

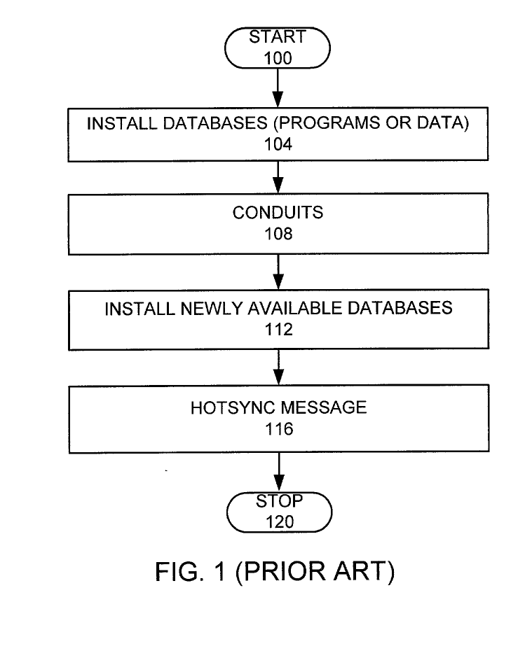

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

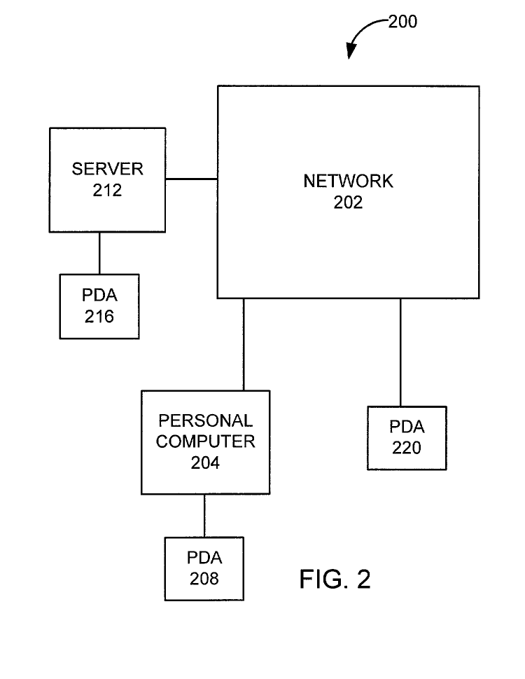

FIG. 2 is a schematic illustration of a system 200, which may use the invention. The system 200 may comprise a server 212, which may contain data stored in databases. The system may be connected by a network 202, which may be connected to a server 212 and a personal computer 204. The network may be a local area network (LAN) or a wide area network (WAN). An example of a LAN is a private network used by a mid-sized company with a building complex. Publicly accessible WANs include the Internet, cellular telephone network, satellite systems and plain-old-telephone systems (POTS). Examples of private WANs include those used by multi-national corporations for their internal information system needs. The network may also be a combination of private and/or public LANs and/or WANs. A first personal digital assistant PDA 208 is connected to the personal computer 204. The first personal digital assistant PDA 208 may be a device that uses the Palm™ Operating System or may be a computing device that uses the Windows CE™ Operating system or some other computer device such as one built by Psion™. In the preferred embodiment of the invention, the PDA is a computing device that uses the Palm™ Operating System and the HotSync™ program to synchronize the PDA with the server 212 or personal computer 204. A second personal digital assistant 216 may be directly connected to the server 212. A third personal digital assistant 220 may be directly connected to the network 202.

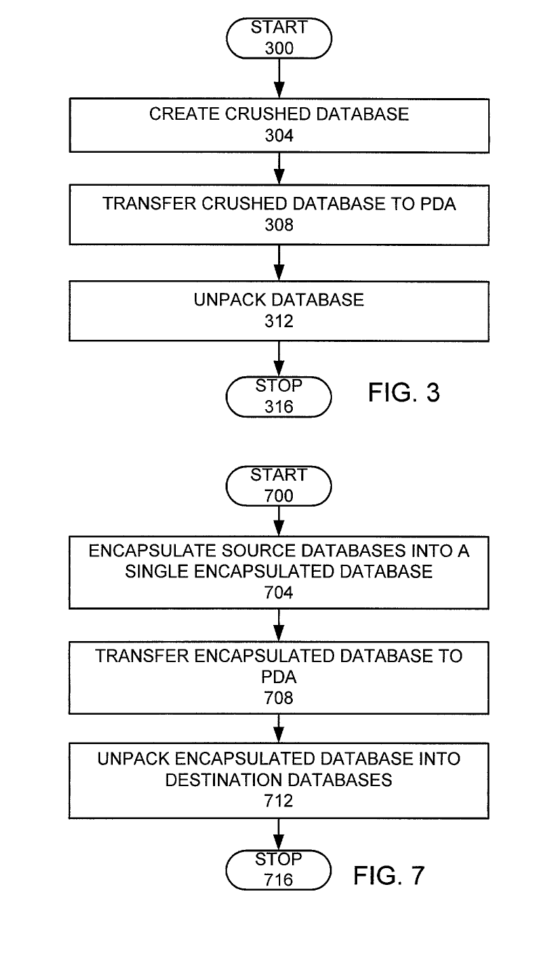

FIG. 3 is a schematic illustration of a process used in a preferred embodiment of the invention. First a source database is crushed to create a crushed database (step 304). The creation of the crushed database may be done by the server 212 or the personal computer 204. A sample algorithm for transforming a database into a crushed database is as follows:

1. Create the ‘Head’ ID=0 resource with the database information (name, type, creator, etc.)

2. Create the ‘RecH’ ID=0 resource with the record sizes and record “unique IDs.”

3. Create the ‘AppI’ ID=0 resource if the output database has “applnfo” meta-data associated with it.

4. Create the ‘SrtI’ ID=0 resource if the output database has “sortlnfo” meta-data associated with it.

5. Create the ‘RecD’ ID=0 (and up) resources containing the packed record data (up to 64K each resource).

First the server creates a “Head” resource, which provides information, such as name, type creator, etc., to create the destination database, without records. The Palm™ Operating System application DMCreateDatabase requires a name, type, creator, etc. to create a Palm™ database. The server then creates the “RecH” resource, which provides information regarding the size of each record. The size of each record indicates where records begin and end within the RecD resources. The server then creates an “AppI” resource, which provides application information, which is meta-data associated with the database. The server then creates a “SrtI” resource, which is sort information, which is meta-data. Any database meta-data, such as the database version, may be stored in the AppI resource or the SrtI resource. The server then creates the “RecD” ID=0 (and up if needed), which are the resources containing the packed record data. In the preferred embodiment a single RecD resource is not greater than 64K. This record contains a unique three byte ID for each packed record in a crush record and the size of each record in the crush record. The crush algorithm fills up a RecD ID record until the next added record would fill the RecD ID record to more than 64K. Then a new RecD resource is created, with the next consecutive ID, to which the next record data is added. The resulting file is a prc file, resource, database that has a name that may be recognized by the crush program.

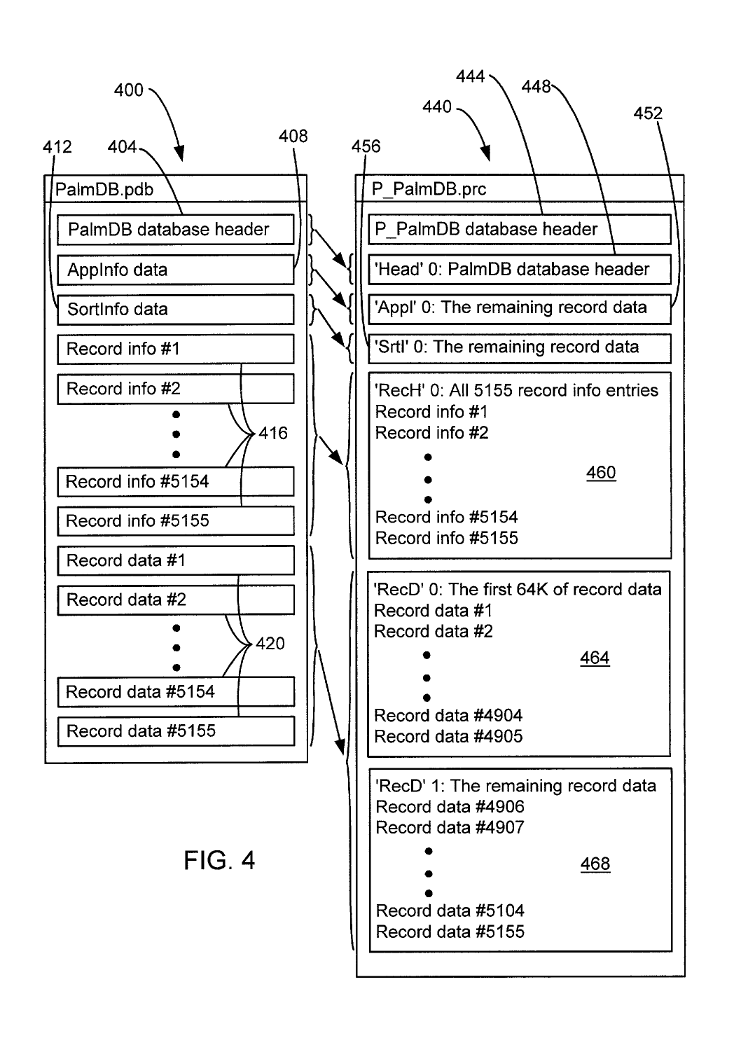

FIG. 4 is a schematic illustration of an example of how the above algorithm repackages a PDB file with 5,155 records into a into a PRC file with only six large resources. In this example the PDB file 400 is called PalmDB.pdb. The PDB file has a header 404, AppInfo data 408, SortInfo data 412, record information 416 and record data 420. The crushed database 440 is called P_PalnDB.prc, so that the crush algorithm may identify it as a crushed database. The crushed database 440 has a header 444. A Head ID=0 resource 448 of the crushed database 440 stores data from the header 404 of the PDB file 400. An AppI ID =0 resource 452 of the crushed database 440 stores the AppInfo data 408. A SortI ID=0 resource 456 of the crushed database 440 stores SortInfo data 412. In this example the PDB file 400 has 5,155 records of record information 416, such as record size, which are stored in a single RecH ID=0 resource 460 of the crushed database 440. This is in the case that the record information of the 5,155 records are less than 64K in size. The PDB file 400 also has 5,155 records of record data 420. In this example the 5,155 records of record data are greater than 64K in size. Therefore, in this example record data for records 1-4905 are stored in the RecD ID=0 resource 464. The addition of record data for record 4906, would cause RecD ID=0 464 to be greater than 64K. Therefore record data for records 4906-5155 are placed in a RecD ID=1 resource 468. Thus a database with 5,155 records is crushed to a crushed database with only six large resources. Although the crushed database may be slightly larger than the original PDB file 400 it has been found empirically that such a crushed database is able to be transferred to a PDA much more quickly than the PDB file 400, due to the elimination of the individual acknowledgements for each of the 5,155 records of the PDB file 400.

Next the crushed database is transferred to the PDA (step 308). If the crushed database is formed on the server 212, a network HotSync™ may be used to download the crushed database to the third PDA 220. A HotSync™ program on the server 212 may be used to transfer the crushed database to the second PDA 216. A HotSync™ program on the personal computer 204 may be used to transfer the crushed database to the first PDA 208. This may occur during the install newly available databases step (step 112) of the HotSync process. As described above, since the crushed database only has six resource records, little acknowledgment time is required even though acknowledgements are sent for each record. In contrast the original database with 5,155 records would use much more acknowledgment time, since such a process would provide an acknowledgment for each of the 5,155 records.

As discussed above, the HotSync™ process sends a “HotSync™ notification” message (step 116) at the end of the HotSync™ process. An unpacking application on the first, second, or third PDA 208, 216, 220 receives the HotSync notification message, which activates the unpacking application. The unpacking application searches the PDA to see if there are any crushed databases stored on the PDA. If a crushed database is found the unpacking application unpacks the crushed database and creates to a regular PDA database from the crushed database (step 312) and deletes the crushed database. The unpacking application may detect and unpack more than one crushed database. A sample algorithm for unpacking the crushed database to create a standard PDA database is as follows:

1. Read the ‘Head’ ID=0 resource.

2. Read the ‘RecH’ ID=0 resource.

3. Read the ‘AppI’ ID=0 resource if present.

4. Read the ‘SrtI’ ID=0 resource if present.

5. Create the destination Palm database, where the Head ID=0 resource becomes the header, the AppI ID=0 becomes the AppInfo data, and the SrtI ID=0 becomes the SortInfo data of the created destination database.

6. Read the first ‘RecD’ resource.

7. For each record in the ‘RecH’ list:

a. Create a new record in the destination database of the size prescribed in the record header, and with the proper “unique ID.”

b. Copy the record's data from the current position of the current ‘RecD’ resource.

c. If the current ‘RecD’ resource has been completely consumed, read the next ‘RecD’ resource.

8. Close the destination database.

This algorithm reads the Head resource and the RecH resource. Then the algorithm reads the AppI resource and SrtI resource, if they are in the database. Using the record size data and other data in the RecH resource the algorithm is able to create a Palm database with the required record sizes and data. The algorithm then copies data from the RecD resource to fill the records.

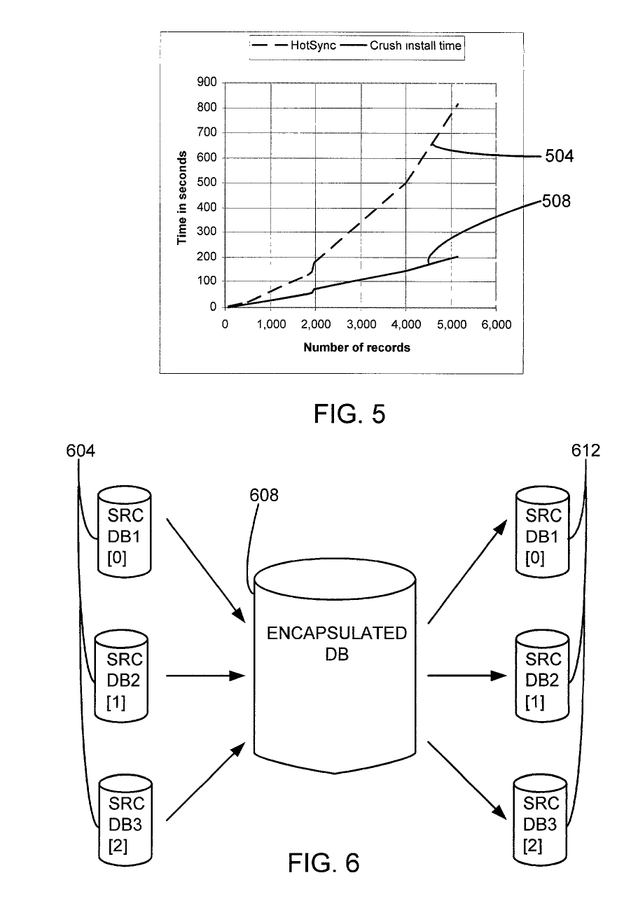

FIG. 5 is a graph which shows HotSync™ install times 504 and Crush install times 508 versus number of records transferred (lower is better). For transferring a database with 5155 records, the HotSync™ program alone required 814 seconds to transfer the database, whereas to crush, transfer by HotSync™ and unpack the same database took only 206 seconds. In the preferred embodiment of the invention, parts of the crushed database are deleted when that part of the crushed database has been unpacked.

FIG. 6 is a schematic illustration of another embodiment of the invention. In the previous embodiment of the invention, a single database was crushed to a crushed database. In this preferred embodiment, more than one database is crushed into a single database. In the specification and claims, when more than one database is crushed to a single database such a process may also be called encapsulation. Such an encapsulation allows both pdb (record) databases and prc (resource) databases to be crushed into a single crushed database.

FIG. 7 is a high level flow chart of the process used in encapsulation. Source databases such as the three source databases 604 in FIG. 6 are encapsulated into a single encapsulated database 608 (step 704). The encapsulated database 608 is then transferred to a PDA (step 708). The PDA may be any PDA, shown for example in FIG. 2, which has a first PDA 208 connected to a personal computer 204, a second PDA 216 connected directly to a server 212, and a third PDA 220 connected directly to a network. In a preferred embodiment of the invention, the HotSync™ process may be used to transfer the encapsulated database 608 to the PDA. After the encapsulated database 608 has been transferred to the PDA the encapsulated database is unpacked into the destination databases 612 (step 712). As described in the previous embodiment, the crushing or encapsulation may be automatically performed during the HotSync™, where during the conduits step 108 the encapsulation may occur. In addition, as described in the previous embodiment, the unpacking of the encapsulated database may be an automatic result of the HotSync™ process in that an unpacking application may receive HotSync™ notification message, which causes the unpacking application to search for encapsulated databases for unpacking. In another embodiment of the invention, the encapsulating and unpacking may be performed by other applications. For example, an encapsulated database creator may manually choose databases to encapsulate and then run an application to encapsulate the chosen source databases. Instead of having an unpacking application, which searches for and unpacks encapsulated databases when a Hotsync™ notification message is received, an unpacking application may be part of a reader program, which searches for a database to read and if a database is not found searches for an encapsulated database to unpack and then read. An embodiment of the invention deletes the encapsulated database after it is unpacked. In another preferred embodiment of the invention, parts of the encapsulated database are deleted after that part is unpacked. Allowing the deletion of parts of the encapsulated database may allow for a lower requirement for free memory space, but may result in corrupt destination databases if the unpacking is stopped mid-stream.

In a comparison of data structures between crush for a single database and crush for multiple databases (encapsulation) the following table compares the crush data structure with the encapsulation data structure, where for encapsulation “nnn” is the encapsulated database number.

| Crush | Encapsulation |
|---|---|
| Head ID 0 | Hnnn ID 0 |
| RecH ID 0 | Snnn ID 0 and up |
| AppI ID 0 | Annn ID 0 |
| SrtI ID 0 | n/a |
| RecD ID 0 and up | Dnnn ID 0 and up |

Therefore, referring to FIG. 6 the first source database (SRC DB1) may be given a header H000, when placed in the encapsulated database. The second source database (SRC DB2) may be given a header H001, when placed in the encapsulated database 608. The third source database (SRC DB3) may be given a header H002, when placed in the encapsulated database 608.

### EXAMPLE

In a specific example of the encapsulated process, often more than one database is required to properly represent the content of a book on a PDA. However, to ease distribution of books, it is desirable to have a book require the download of only a single database to the PDA. To that end, a book reader program may support a book encapsulation program, which allows all the (record-based) databases required for a book to be (temporarily) encapsulated into the book database, and extracted upon first viewing of the book.

When a book database is first opened, the book reader program iterates through the ‘dbls’ resource to confirm that required databases are present. If they are not, it looks for a set of encapsulation resources, described below. If these resources are found, it uses them to extract multiple databases from the book database. As databases are extracted, the resources from which they were derived are deleted, thus freeing memory on the PDA.

All the information required to extract the databases is provided in three or more resources per output database. Central to this extraction is the concept of an output database index (ODI). The ODI for a database is simply the position (zero-based) of that database the ‘dbls’ resource from the book database. An example is in the table below:

| Name | Type | Implied Output Database Index (ODI) |
|---|---|---|
| ER_AZTxCategories | ‘aztc’ | 0 |
| ER_AZNames | ‘aznm’ | 1 |
| ER_AZMonographs | ‘azmg’ | 2 |

This example lists the databases required by a data set called the Facts & Comparisons A-Z data set, which uses a book reader program called the ‘dgrf’ reader. Three additional databases (beyond the book database itself) are required by the ‘dgrf’ reader, and this resource tells the ‘dgrf’ reader how to open them. When the ‘dgrf’ reader discovers that it cannot open these databases, it uses the ODI (shown above) to look for encapsulation resources from which to extract those databases.

In this example, encapsulated book databases are made up of three or more resources, the types of which are derived from the ODI. The following table provides the resource types in this example, where “nnn” represents a three digit integer:

Encapsulation Resources

| Type | ID or Ids | Contents |
|---|---|---|
| ‘Hnnn’ | Always ID = 0 | The database header for the output database |
| ‘Annn’ | Always ID = 0 | The appInfo data for the output database |
| ‘Snnn’ | 0 up | Up to 32,000 16-bit record sizes, as many |
| | | resources as needed |
| ‘Dnnn’ | 0 up | Up to 64,000 bytes of record data, rounded to |
| | | a whole record |

The basic idea is that the ‘Hnnn’ resources provide enough information to create the database and its applnfo block, then the ‘Snnn’ and ‘Dnnn’ resources provide enough information to populate the database with all its records.

As an example of a resource type, for ODI 0 (ER_AZTxCategories in the ‘dbls’ resource), the resource types would be ‘H000’, ‘A000’, ‘S000’, and ‘D000’. For ODI 1 (ER_AZNames in the ‘dbls’ resource), the resource types would be ‘H001’, ‘A001’, ‘S001’, and ‘D001’, etc.

The ‘Hnnn’ resources contain a fixed-size PalmOS database header, given in the format below.

‘Hnnn’ resource format:

| Field Name | Type | Description |
|---|---|---|
| Name | Zero-term | Database name (padded to 32 bytes) |
| | string[32] | |
| Flags | UInt16 | Flags (ignored) |
| CreationDate | UInt32 | Creation date (in seconds) |
| ModDate | UInt32 | Modification date (in seconds) |
| BackupDate | Uint32 | Last backup date (in seconds) |
| ModNumber | UInt32 | Modification number (ignored) |
| AppInfoOffset | UInt32 | AppInfo data offset (ignored) |
| SortInfoOffset | UInt32 | SortInfo data offset (ignored) |
| Type | UInt32 | Four-character database type |
| Creator | UInt32 | Four-character database creator |
| UniqueIDSeed | UInt32 | Unique ID seed (ignored) |
| NextRecordListID | UInt32 | Next record list ID (ignored) |
| NumRecords | UInt16 | Number of records in the database |

The three dates are in seconds since midnight, Jan. 1, 1904 (a standard Macintosh date-time). Most of the other fields are zeros. Crucial are the four-character database type and creator.

The ‘Annn’ resource is optional. If provided the data in ‘Annn’ ID=0 will be used to populate the output database's appInfo block.

Since PalmOS database records are limited to 64,000 bytes (approximately), but the overall size of book databases may be significantly larger than that, it may be that the data for a given database must be spread over multiple ‘Dnnn’ resources. To find and extract the records for a database, the dgrf reader needs the sizes of each record, which allows it to consume bytes from the ‘Dnnn’ data records. The sizes are in a list. One size per output database record is stored in the ‘Snnn’ resources.

Each record size requires two bytes, so additionally, more than one ‘Snnn’ resource may be required to represent the sizes of all the records in the output database due to the maximum PalmOS record size.

An important point is that the ‘Snnn’ and ‘Dnnn’ resource IDs are co-related. For instance, for ODI 1, resource ‘S001’ ID=1 will contain the record sizes of the data records encapsulated in ‘D001’ ID=1. This typically means that the size of the ‘Snnn’ resources is much smaller than the ‘Dnnn’ resource with the same ID.

In this example, the Facts & Comparisons A-Z database contained only three drugs, but the monographs for those drugs were very large (say, 40,000 bytes for the first drug, and 20,000 each for the other two). The encapsulation resources that would be required are as follows:

‘H000’, ID = 0

| Field Name | Value | Description |
|---|---|---|
| Name | ‘ER_AZTxCategories’ | Database name |
| | | (padded to 32 bytes) |
| Flags | 0x0000 | Flags |
| CreationDate | 0xb5b0b8b5 | Creation date |
| | | (in seconds) |
| ModDate | 0xb5b0b8b5 | Modification date |
| | | (in seconds) |
| BackupDate | 0x00000000 | Last backup date |
| | | (in seconds) |
| ModNumber | 0x00000000 | Modification number |
| AppInfoOffset | 0x00000000 | AppInfo data offset |
| SortInfoOffset | 0x00000000 | SortInfo data offset |
| Type | ‘aztc’ | Four-character database |
| | | type |
| Creator | ‘ePrf’ | Four-character database |
| | | creator |
| UniqueIDSeed | 0x00000000 | Unique ID seed |
| NextRecordListID | 0x00000000 | Next record list ID |
| NumRecords | 0x0001 | Number of records in the |
| | | database |

‘S000’,ID = 0
Record Size
4
‘D000’, ID = 0
Record Data
‘CNS’, 0x00
‘H001’, ID = 0

| Field Name | Value | Description |
|---|---|---|
| Name | ‘ER_AZNames’ | Database name |
| | | (padded to 32 bytes) |
| Flags | 0x0000 | Flags |
| CreationDate | 0xb5b0b8b5 | Creation date |
| | | (in seconds) |
| ModDate | 0xb5b0b8b5 | Modification date |
| | | (in seconds) |
| BackupDate | 0x00000000 | Last backup date |
| | | (in seconds) |
| ModNumber | 0x00000000 | Modification number |
| AppInfoOffset | 0x00000000 | AppInfo data offset |
| SortInfoOffset | 0x00000000 | SortInfo data offset |
| Type | ‘aznm’ | Four-character database |
| | | type |
| Creator | ‘ePrf’ | Four-character database |
| | | creator |
| UniqueIDSeed | 0x00000000 | Unique ID seed |
| NextRecordListID | 0x00000000 | Next record list ID |
| NumRecords | 0x0003 | Number of records in the |
| | | database |

```
‘S001’, ID = 0
Record Size
11
  8
  7
‘D001’, ID = 0
Record Data
‘alprazolam’, 0x00
‘Aricept’, 0x00
‘BuSpar’, 0x00
‘H002’, ID = 0
```

| Field Name | Value | Description |
|---|---|---|
| Name | ‘ER_AZMonographs’ | Database name |
| | | (padded to 32 bytes) |
| Flags | 0x0000 | Flags |
| CreationDate | 0xb5b0b8b5 | Creation date |
| | | (in seconds) |
| ModDate | 0xb5b0b8b5 | Modification date |
| | | (in seconds) |
| BackupDate | 0x00000000 | Last backup date |
| | | (in seconds) |
| ModNumber | 0x00000000 | Modification number |
| AppInfoOffset | 0x00000000 | AppInfo data offset |
| SortInfoOffset | 0x00000000 | SortInfo data offset |
| Type | ‘azmg’ | Four-character database |
| | | type |
| Creator | ‘ePrf’ | Four-character database |
| | | creator |
| UniqueIDSeed | 0x00000000 | Unique ID seed |
| NextRecordListID | 0x00000000 | Next record list ID |
| NumRecords | 0x0003 | Number of records in the |
| | | database |

‘S002’,ID = 0
Record Size
40000
‘D002’, ID = 0
Record Data
0x01,...0x00 (40000
bytes)
‘S002’, ID = 1
Record Size
20000
20000
‘D002’, ID = 1
Record Data
0x01,...0x00 (20000
bytes)
0x02,...0x00 (20000
bytes)

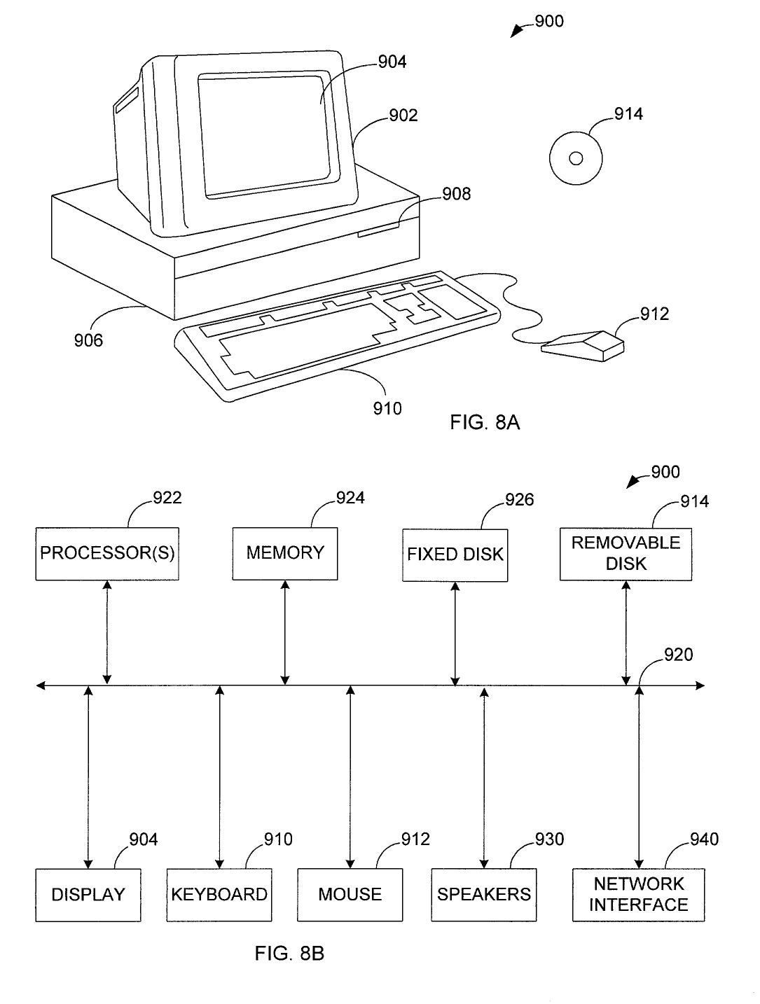

FIGS. 8A and 8B illustrate an example of a computer system 900, which is suitable for implementing embodiments of the present invention. FIG. 8A shows one possible physical form of the computer system. Of course, the computer system may have many physical forms ranging from an integrated circuit, a printed circuit board and a small handheld device up to a huge super computer. In this example the computer system 900 includes a monitor 902, a display 904, a housing 906, a disk drive 908, a keyboard 910 and a mouse 912. Disk 914 is a computer-readable medium used to transfer data to and from computer system 900.

FIG. 8B is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data and the like and is typically a secondary storage medium (such as a hard disk) that is slower than primary storage. It will be appreciated that the information retained within fixed disk 926, may, in appropriate cases, be incorporated in standard fashion as virtual memory in memory 924. Removable disk 914 may take the form of any of the computer-readable media described below.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

Generally a personal digital assistant PDA would be a computer system that does not have a hard drive and has an interface that allows the PDA to synchronize with a larger computer system. This interface may be a LAN, WAN, or direct or indirect connection to another computer system such as serial, parallel, IrDA, USB, IEEE 1394, or other interfaces. Instead of using a hard drive to store data, a PDA may use RAM memory as a data storage device. In addition, a PDA may have a touch screen and built in keys for allowing input.

An advantage of encapsulation is that currently it is common that to install a program on a PDA several individual databases must be installed for each program. It is more difficult to install several individual databases than to install a single database. Encapsulation allows a single database to be installed, which is then extracted into several databases for use on the PDA. The installation of a single database is a much easier process, and transfer times are also reduced. Windows CE may have a transfer program similar to HotSync™. Embodiment of the invention using Windows CE PDA's would use such a similar transfer program.

While this invention has been described in terms of several preferred embodiments, there are alterations, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. A computer implemented method of transferring data from a first computer system to a second computer system, comprising:
packaging data from a plurality of first source database records into a first single record;
transferring the first single record from the first computer system to the second computer system; and
unpackaging the first single record into a plurality of database records.

2. The method, as recited in claim 1, wherein the second computer system is a personal digital assistant.

3. The method, as recited in claim 2, wherein the packaging data from a plurality of first source database records into a first single record forms an encapsulated database, further comprising packaging the sizes of each of the plurality of first source database records into a second single record in the encapsulated database.

4. The method, as recited in claim 3, further comprising the step packaging data from a plurality of second source database records into a third single record within the encapsulated database.

5. The method, as recited in claim 4, further comprising packaging the sizes of each of the plurality of second source database records into a fourth single record in the encapsulated database.

6. The method, as recited in claim 5, wherein transferring the single record is performed by a HotSync™ program.

7. The method, as recited in claim 5, wherein the unpackaging the first single record into the plurality of database records forms a first destination database of the plurality of database records.

8. The method, as recited in claim 7, further comprising unpackaging the third single record into a plurality of database records, which form a second destination database.

9. The method, as recited in claim 8, wherein the unpackaging the first single record uses data in the second single record.

10. The method, as recited in claim 9, wherein the unpackaging the third single record uses data in the fourth single record.

11. The method, as recited in claim 1, wherein transferring the single record is performed by a HotSync™ program.

12. A computer implemented method of transferring data from a first computer system to a second computer system, comprising:
encapsulating a plurality of source databases into a single encapsulated database;
transferring the en capsulated database from the first computer system to the second computer system; and
unpacking the single encapsulated database into a plurality of destination databases.

13. The method, as recited in claim 12, wherein the second computer system is a personal digital assistant.

14. The method, as recited in claim 13, wherein the encapsulating the plurality of source database comprises encapsulating a first source database of the plurality of source databases, which comprises packaging data from a plurality of records of the first source database into a first single record of the encapsulated database.

15. The method, as recited in claim 14, wherein the encapsulating the first source database further comprises packaging the size of each record of the plurality of records of the first source database into a second single record in the encapsulated database.

16. The method, as recited in claim 15, wherein the encapsulating the plurality of source database further comprises encapsulating a second source database of the plurality of source databases, which comprises packaging data from a plurality of records of the second source database into a third single record of the encapsulated database.

17. The method, as recited in claim 16, wherein the encapsulating the second source database further comprises packaging the size of each record of the plurality of records of the second source database into a fourth single record in the encapsulated database.

18. The method, as recited in claim 17, wherein transferring the single record is performed by a HotSync™ program.
